(19) United States
(12) Patent Application Publication
(10) Pub. No.: US 2016/0020833 A1
(43) Pub. Date: Jan. 21, 2016

(54) RING SETTING TYPE NEAR FIELD COMMUNICATION RING DEVICE

(71) Applicant: Shao-Chieh TING, New Taipei City (TW)

(72) Inventor: Shao-Chieh TING, New Taipei City (TW)

(21) Appl. No.: 14/336,693

(22) Filed: Jul. 21, 2014

(51) Int. Cl. H04B 5/00; H04B 1/3827

(52) U.S. Cl. CPC H04B 5/0081; H04B 1/385; H04B 5/0031; H04B 2001/3861

(57) ABSTRACT

The present invention uses hard material to form a ring setting type ring, and a slightly cambered surface is formed in the ring setting surface. A NFC (Near Field Communication) circuit board component is firmly fixed inside a groove of the ring setting surface, and then encapsulated using a room temperature-solidifiable and waterproof resin adhesive, thereby improving the frequently seen shortcoming of failure in the NFC circuit board component failure because of the high temperatures during encapsulation. Moreover, the ring is provided with slots for placement of capacitance electronics or related parts therein, thus achieving optimum receiving and transmitting information effectiveness. When the ring is made from metal material, a repeater plate needs to be disposed below the NFC circuit board component to prevent interference.

### BACKGROUND OF THE INVENTION

(a) Field of the Invention

The present invention relates to a ring setting type NFC (Near Field Communication) ring device, and more particularly to a ring setting type NFC ring device in which a circuit board component is mounted on a slightly cambered surface of a ring setting, and is then encapsulated using a room temperature-solidifiable and waterproof resin adhesive.

(b) Description of the Prior Art

Near Field Communication (abbreviated to NFC), is a short range wireless communication technology. Moreover, NFC is a non-contact recognition and intercommunication technology which can implement short range wireless communication between portable devices, consumer electronic products, PCs (personal computers), and smart controlled appliances.

Commonly seen NFC short range wireless communication rings are normally made from metal for aesthetic appearances. In addition, decorated plastic rubber is used to enable an NFC circuit and an antenna coil or PCB (Printed Circuit Board) to be disposed between the plastic rubber and the curved ring surface, thereby enabling the NFC component to penetrate the plastic rubber and transmit a wireless signal via a NFC communication mode. Moreover, the above-mentioned NFC short range wireless communication rings have poor waterproofing, and because of the excessively curvature, the effectiveness of the NFC circuit containing the antenna to receive and transmit information is poor.

Hence, in light of the aforementioned shortcomings, and pursuing the spirit of excellence in research and development, the inventors of the present invention have found a way to improve the aforementioned shortcomings, and thus propose a ring setting type NFC ring device of the present invention, which further provides an aesthetic appearance and convenience of use.

### SUMMARY OF THE INVENTION

A primary objective of the present invention lies in mounting a NFC circuit board component on a slightly cambered surface of a ring setting of a ring made from hard material, which is then encapsulated using a room temperature-solidifiable and waterproof resin adhesive. And a wide space is further hollowed out from the soft PCB (printed circuit board) of the NFC circuit board component to the inner edge of the ring to provide a placement slot for disposing NFC circuit related capacitance electronics or related parts therein, thereby strengthening the application function of the ring, as well as achieving the requirement for an aesthetic appearance.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an elevational schematic view of the present invention.

FIG. 2 is a three-dimensional exploded schematic view of the present invention.

FIG. 3 is a cross-sectional perspective view of the present invention.

### DETAILED DESCRIPTION OF THE PREFERRED EMBODIMENTS

Regarding the detailed content and structural means of the present invention, please refer to the description of the diagrams as follows:

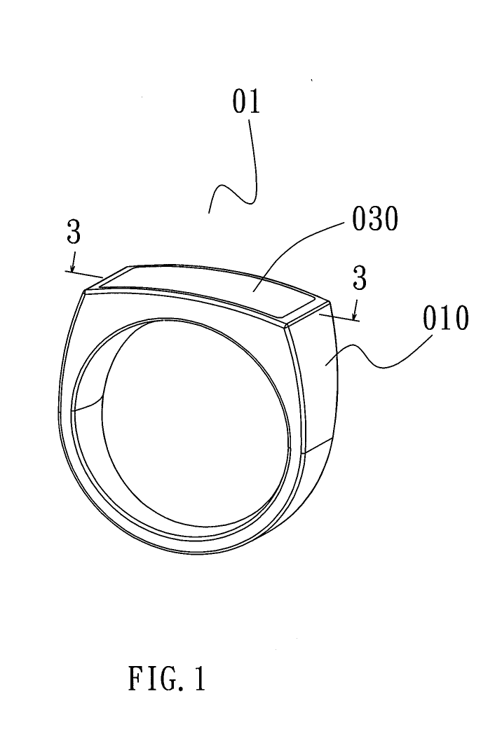

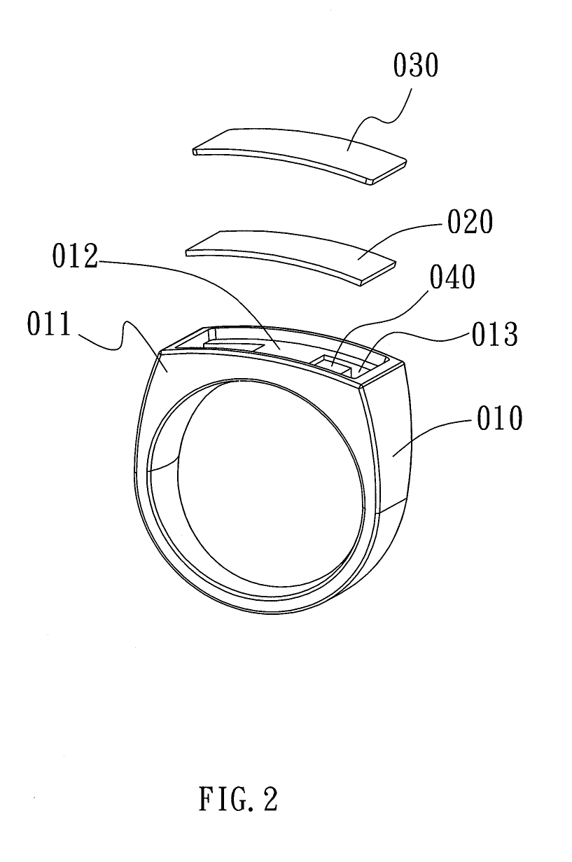

Referring to FIG. 1 and FIG. 2, which disclose an elevational schematic view and a three-dimensional exploded schematic view respectively of a ring setting type NFC (near field communication) ring device of the present invention, primarily comprising a ring 010 made from hard material, a NFC circuit board component 020, and a room temperature-solidifiable and waterproof resin adhesive 030. Wherein the top portion of the ring 010 is provided with a slightly cambered surface ring setting 011, and a groove 012 which is used to dispose the NFC circuit board component 020.

As for the NFC circuit board component 020, if the ring 010 is made from metal material, then a repeater plate needs to be disposed below the NFC circuit board component 020 to provide a function that prevents the metal from interfering with an antenna receiving and transmitting information. A wide space is further hollowed out from the soft PCB (printed circuit board) of the NFC circuit board component 020 to the inner edge of the ring 010 to provide a placement slot 013 for disposing NFC circuit related capacitance electronics or related parts 040 therein, and the room temperature-solidifiable and waterproof resin adhesive 030 is used to encapsulate the NFC circuit board component 020, thereby not only improving the frequently seen shortcomings of NFC ring devices, but also achieving the objectives of waterproofing the ring and providing an aesthetic design.

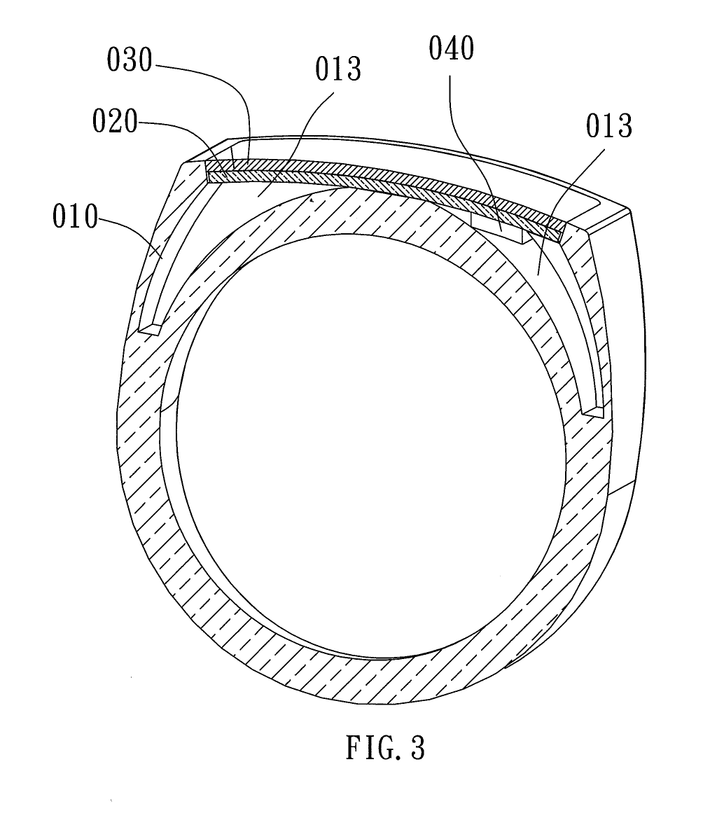

FIG. 3 discloses a cross-sectional view of the slightly cambered ring setting surface of the NFC ring device 01 (as shown in FIG. 1) of the present invention.

In conclusion, the design of the ring setting type NFC ring device of the present invention is certainly provided with innovativeness and advancement, and the use of technology is undoubtedly new and original. The effectiveness of the present invention successfully fulfills the design objectives, and clearly provides reasonable advancement. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A ring setting type Near Field Communication (NFC) ring device, comprising a ring structured from hard material, a NFC (near field communication) circuit board component, and a room temperature-solidifiable and waterproof resin adhesive; a top portion of the ring is provided with a slightly cambered surface ring setting, which is provided with a groove; the groove is used to dispose the NFC circuit board component, and enables filling with a room temperature-solidifiable and waterproof resin adhesive.

2. The ring setting type Near Field Communication ring device according to claim 1, wherein the NFC circuit board component is disposed inside the groove of the ring setting, and is then encapsulated using the room temperature-solidifiable and waterproof resin adhesive.

3. The ring setting type Near Field Communication ring device according to claim 1, wherein a wide space is hollowed out from a soft PCB (printed circuit board) of the NFC circuit board component to an inner edge of the ring to provide a placement slot for disposing NFC circuit related capacitance electronics or related parts therein.

4. The ring setting type Near Field Communication ring device according to claim 1, wherein a repeater plate is disposed below the NFC circuit board component when the ring is made from metal material.
